(19) United States
(12) Patent Application Publication
(10) Pub. No.: US 2002/0100743 A1
(43) Pub. Date: Aug. 1, 2002

(54) Multi-step polish process to control uniformity when using a selective slurry on patterned wafers

(76) Inventors: Benjamin A. Bonner, San Mateo, CA (US); Thomas H. Osterheld, Mountain View, CA (US); Peter McKeever, Sunnyvale, CA (US); Jeffrey Drue David, San Jose, CA (US)

Correspondence Address: Patent Counsel, M/S 2061, Legal Affairs Department, Applied Materials, Inc., P.O. Box 450A, Santa Clara, CA, 95052, US

(21) Appl. No.: 09/731,264

(22) Filed: Dec. 5, 2000

(51) Int. Cl. B44C 1/22

(52) U.S. Cl. 216/53; 216/89

(57) ABSTRACT

A multistep method of polishing a semiconductor substrate with a polishing fluid to remove a selected amount of material from the substrate. In one embodiment the method includes polishing the substrate to remove a first portion of the selected amount of material by holding the substrate against a polishing pad with a polishing force and applying a polishing solution to the polishing pad. Next the polishing pad is rinsed with a rinsing fluid, and afterwards the substrate is further polished to remove a second portion of the selected amount of material by holding the substrate against the polishing pad with a polishing force and applying the polishing fluid to the polishing pad.

### BACKGROUND OF THE INVENTION

The present invention relates to the field of semiconductor processing. More specifically, embodiments of the invention relate to a method for polishing and/or planarizing semiconductor wafers and the films formed thereon.

Modem day semiconductor devices are typically formed on silicon substrates and include multiple metalization layers as part of an interconnect structure. Each metalization layer is separated from an adjacent metalization layer or the silicon substrate by a dielectric layer, such as an oxide layer. Connections between the metal layers and/or substrate are made with vias or contact holes. One common sequence used to form an interconnect for a multi-layer device includes depositing and patterning a first metal layer over the device, depositing an intermediate oxide over the patterned first metal layer, photolithographically defining a via hole in the oxide and depositing a second metal layer over the oxide that fills the contact hole and contacts the patterned first metal layer.

Often undesirable steps or undulations must be removed from the silicon substrate or from one of the metal or oxide layers before another layer can be formed thereon. To remove steps or undulations, the silicon oxide or metal is preferably planarized, removing any steps or undulations formed therein, prior to deposition of a layer thereon. One method of achieving planarization includes forcing the semiconductor wafer face down against a polishing pad which is saturated with a polishing fluid (e.g., a slurry or polishing chemical) and moving the polishing pad relative to the wafer. The relative movement between the polishing pad and the wafer mechanically removes layers of material and is continued until the steps or undulations are removed. This process is generally referred to as chemical mechanical polishing (CMP).

The polishing fluid used in a CMP process typically includes several different components mixed together in a solution, such as an abrasive mixed with one or more additives. Some polishing fluids are relatively stable and can be mixed and subsequently stored for long periods prior to use. Other polishing fluids are relatively unstable and are thus mixed in a point-of-use mixing system shortly before use.

A variety of different point-of-use mixing systems have been developed for use with CMP tools. Passive mixing systems generally mix various components of the polishing fluid passively by e.g., combining multiple fluids from separate fluid lines into a combined line. Dynamic mixing systems, on the other hand, include a mechanical mixing or similar device to more thoroughly blend the different polishing fluid components together.

Dynamic mixing systems are generally able to achieve more uniform and predictable polishing results as compared to passive mixing systems. Despite the use of such dynamic mixing systems, however, it is desirable to improve polishing uniformity and predictability further.

### SUMMARY OF THE INVENTION

The present invention provides an improved method of polishing semiconductor wafers that is particularly useful for polishing with unstable polishing fluids. As used herein, a “polishing fluid” is a fluid that can be used in a CMP process to polish a substrate and an “unstable polishing fluid” is a polishing fluid that when used in a CMP step exhibits a polishing removal rate that decreases with time under conditions where other polishing fluids are stable, e.g., due to pad conditioning. Embodiments of the invention are useful in both batch and inline polishing processes.

In one embodiment of the method of the present invention, a multistep method of polishing a semiconductor substrate with a polishing fluid to remove a selected amount of material from the substrate is disclosed. The method includes polishing the substrate to remove a first portion of the selected amount of material by holding the substrate against a polishing pad with a polishing force and applying a polishing solution to the polishing pad. Next the polishing pad is rinsed with a rinsing fluid, and afterwards the substrate is further polished to remove a second portion of the selected amount of material by holding the substrate against the polishing pad with a polishing force and applying the polishing fluid to the polishing pad.

In another embodiment of the method of the present invention, a semiconductor substrate is polished in a polishing system that includes at least first and second polishing stations. The first polishing station includes a first polishing pad and the second polishing station includes a second polishing pad. The method includes transferring the substrate to the first polishing, polishing the substrate at the first station to remove a first portion of material by holding the substrate against the first polishing pad with a polishing force and applying a first polishing solution to the first polishing pad, rinsing the first polishing pad with a rinsing fluid and polishing the substrate to remove a second portion of material by holding the substrate against the first polishing pad with a polishing force while applying the first polishing fluid to the first polishing pad. The substrate is then transferred to the second polishing station where it is polished to remove a third portion of material by holding the substrate against the second polishing pad with a polishing force and applying a second polishing solution to the second polishing pad.

These and other embodiments of the present invention, as well as its advantages and features, are described in more detail in conjunction with the text below and attached figures.

### BRIEF DESCRIPTION OF THE DRAWINGS

FIG. 1 is a top plan view of a portion of an exemplary chemical mechanical polishing device that can be used to practice one embodiment of the method of the present invention;

FIG. 2 is a flowchart of the steps according to one embodiment of the method of the present invention used in a batch CMP process;

FIG. 3 is a top plan view of a portion of an exemplary chemical mechanical polishing device that can be used to practice another embodiment of the method of the present invention; and

FIG. 4 is a simplified cross-section of an example substrate in which shallow trench isolation structures are formed.

### DESCRIPTION OF THE SPECIFIC EMBODIMENTS

I. Introduction

The present invention provides an improved method of polishing semiconductor wafers using CMP techniques. Embodiments of the invention are useful for both batch and inline polishing processes. As used herein, a batch polishing process is a polish that is performed entirely on one platen. In a batch process, the polishing process starts and continues until completion on the same platen. In contrast, an inline polishing process refers to a process in which the wafer is polished using two or more platens of a CMP tool. For example, one example of an inline polishing process that is used to polish 1000 Å of a silicon oxide layer may polish the first 500 Å on a first platen and then transfer the halfway polished wafer to a second platen where the remaining 500 Å is polished. It is common in such inline processes to rinse each platen with deionized water as the wafer is transferred between platens.

While the method of the present invention can be used in a variety of CMP processes, embodiments of the present invention are particularly useful for CMP processes that employ an unstable polishing fluid. One example of an unstable polishing fluid is a slurry available from Hitachi Chemical Co. Ltd. that is referred to herein as the “Hitachi Chemical” slurry. The Hitachi Chemical includes an HS-8005 abrasive (primarily cerium oxide diluted in water) and a polycarboxylate additive, such as HS-8102-GP or HS-8103-GPE. The Hitachi Chemical slurry is a selective slurry that can be used for polishing shallow trench isolation (STI) applications. The slurry selectively removes oxide as compared to nitride and exhibits an oxide removal rate that decreases significantly during the polishing period (e.g., during one minute of polishing) where the decrease is not due to improper pad conditioning. The polishing properties of the Hitachi Chemical slurry can be contrasted with most slurries commonly used in CMP processes where removal rate of the polished material is substantially constant with time when the polishing pad is properly conditioned.

The inventors have discovered a method that reduces overall polishing time and improves polishing uniformity when an unstable polishing fluid such as HS 8005 is used to remove material from a wafer. The method divides the polishing step into at least two separate polishing substeps with a rinse step inserted between the polish substeps. The rinse step rinses used polishing fluid from the polishing pad and allows the subsequent polish substep to continue or complete the polishing process at a faster polishing rate than would be achievable without the rinse step and at improved uniformity and planarity. The timing of the rinse step can be optimized to give the best performance in terms of throughput, uniformity and other criteria.

II. Description of a Batch CMP Process According to One Embodiment of the Present Invention

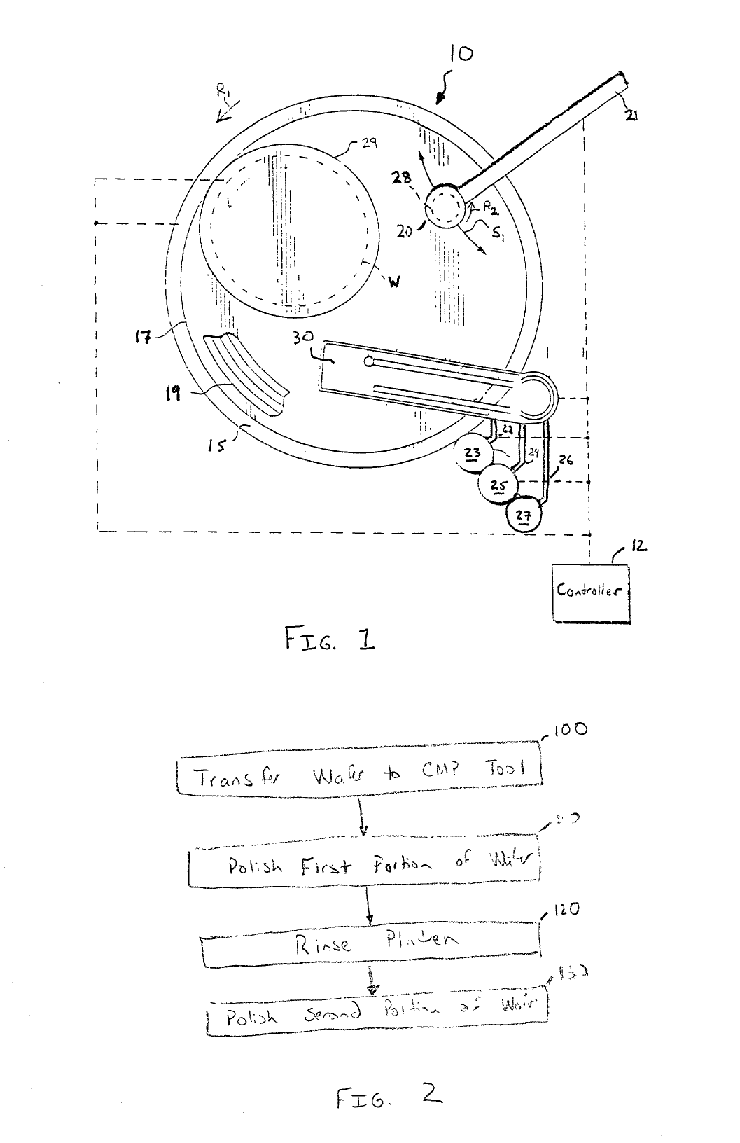

A description of a batch CMP Process according to one embodiment or the present invention is set forth below in conjunction with FIGS. 1 and 2. FIG. 1 is a top plan view of a portion of an exemplary chemical mechanical polishing device 10 that can be used to practice one embodiment of the method of the present invention. Polishing device 10 includes a platen 15 on which a polishing pad 17 for polishing semiconductor wafers is mounted. Platen 15 is rotatable and the polishing pad 17 has at least one groove 19 and typically has a plurality of concentric circumferential grooves 19. Polishing device 10 also includes a pivot arm 21, a holder or conditioning head 20 mounted to one end of pivot arm 21, a pad conditioner 28, such as a disk embedded with diamond crystals, mounted to the underside of the conditioning head 20, a wafer mounting head 29 operatively coupled to platen 15 so as to selectively press a wafer W against polishing pad 17 and an overhead polishing fluid dispenser 30 that supplies polishing fluids, conditioning fluids and rinsing fluids to polishing pad 17. A controller 12 is coupled to the mechanisms which actuate platen 15, pivot arm 21, conditioning head 20, polishing fluid supply line 22, and rinsing fluid supply line 24. Controller 12 is programmed to perform the inventive multi-step, polishing process described below.

Overhead polishing fluid dispenser 30 receives fluid from a slurry/chemical polishing fluid supply line 22 that is fluidly coupled to a polishing fluid source 23, a rinsing fluid supply line 24 that is fluidly coupled to a rinsing fluid (e.g., deionized water) source 25 and a conditioning fluid supply line 26 that is fluidly coupled to a conditioning fluid 28 supply. In some embodiments polishing fluid source 23 is a point of use mixing system where polishing fluid is mechanically mixed in source 23 prior to distributing the fluid through line 22 to polishing device 10. In such embodiments, fluid source may include two or more separate fluid tanks that are fluidly coupled together where polishing fluid is first mechanically mixed in a first tank and then transferred to a second, settling tank prior to be drawn through line 22 to pad 17.

Platen 15 sits on a table top (not shown) that includes drains (also not shown) that allow used liquid and slurry to be drained from polishing device 10. Polishing device 10 also includes a wall (not shown) that surrounds platen 15 and contains liquid and slurry used during polishing within the polishing device. A sliding door exists in the wall to allow wafers to be transferred into polishing device 10 and onto wafer head 29 from a wafer cassette positioned outside the device. Polishing device 10 can include a single or multiple platens 15.

In operation, a wafer W is transferred onto wafer head 29 prior to polishing (FIG. 2, step 100). Polishing is then initiated and a first portion of material is removed from wafer W by holding the wafer face down against polishing pad 17 with wafer head 29 with a polishing force of X (FIG. 2, step 110). The value of X varies with different polishing processes but is typically between 2 and 8 psi. During polishing step 110, a polishing fluid is supplied to pad 17 from polishing fluid source 23 through supply line 22.

After the first portion of material is removed from wafer W, the flow of polishing fluid is stopped, the polishing force is removed and pad 17 is rinsed with deionized water or a similar rinsing fluid (FIG. 2, step 120). The rinsing fluid is supplied to pad 17 through fluid line 24 from rinsing fluid supply 25. Rinse step 120 lasts long enough to remove most of the used polishing fluid, which typically may be between 5 and 30 seconds. Wafer W need not be removed from polishing pad 17 during this rinse process, however. In currently preferred embodiments, wafer W is held face down against the polishing pad with a force of 0 psi so that the wafer essentially floats on the pad without being polished.

Once pad 17 is rinsed, flow of the rinsing fluid is stopped and polishing is continued by reflowing the polishing fluid and pressing wafer W against pad 17 with an appropriate polishing force (FIG. 2, step 130). Polishing step 130 completes the polishing of wafer W by removing a second portion of material from the wafer. Conditioning of pad 17 is done sometime after step 130 when wafer W has been completely polished. Typically, conditioning of pad 17 will be done by applying a conditioning fluid to the pad from fluid supply 27 while wafer W is being transferred to or from platen 15. Alternatively, conditioning can be done in situ (while the wafer is being polished) as is known in the art.

In other embodiments, additional rinse and polishing steps can be added after step 130 when the total thickness of material to be removed from wafer W is sufficiently thick. While the batch polishing process of FIG. 2 was described with respect to a single wafer W polished in a polishing device 10 it is to be understood that polishing device 10 can includes multiple platens 15 and thus polish multiple wafers 10 simultaneously using a similar batch polishing process.

III. Description of an Inline CMP Process According to Another Embodiment of the Present Invention

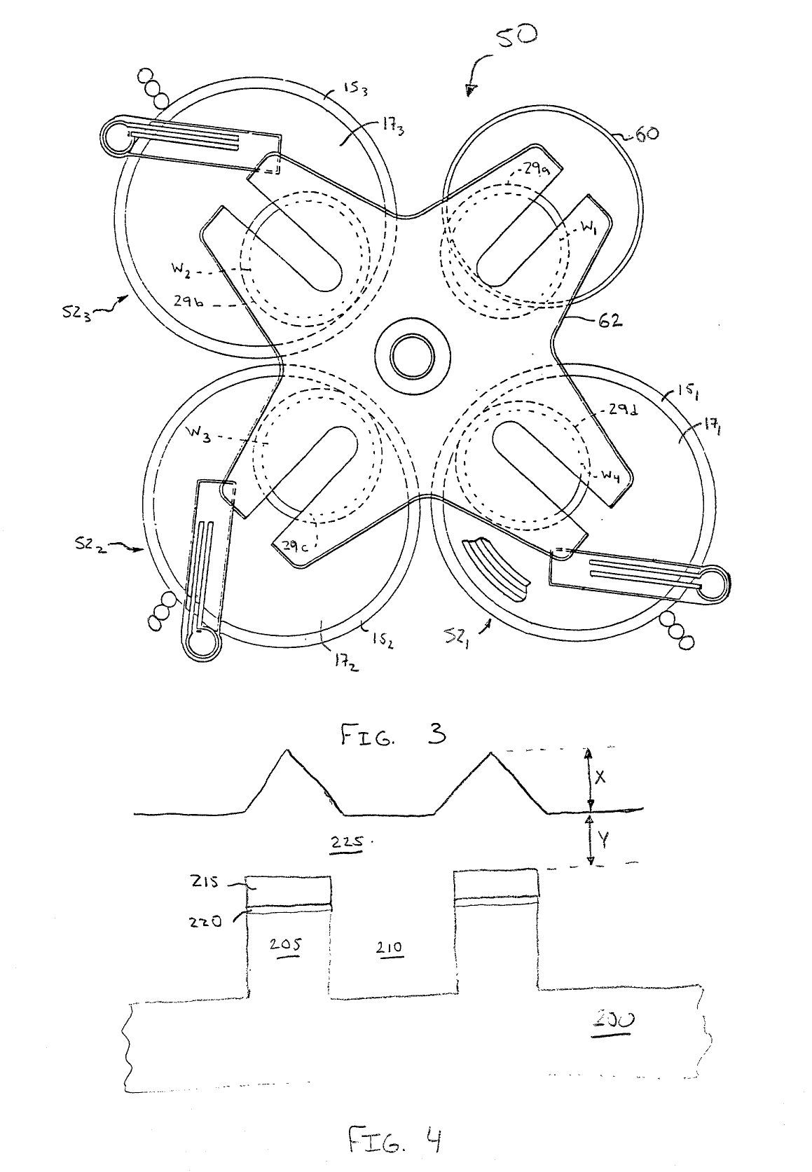

The present invention can also be used to polish wafers in an inline process. A description of an inline CMP Process according to another embodiment of the present invention is set forth below in conjunction with FIG. 3. FIG. 3 is a top plan view of a portion of an exemplary chemical mechanical polishing system 50 that can be used to practice another embodiment of the method of the present invention. Polishing system 50 includes multiple polishing stations 52₁-52₃, each of which is configured to perform standard polishing operations. Many of the elements of each polishing station 52₁-52₃ are similar to elements described above with respect to polishing device 10. Accordingly, like reference numerals, with the addition of subscripts to denote station numbers, between FIGS. 1 and 3 are used to identify corresponding components.

Polishing system 50 includes a load cup 60 and a rotatable cross bar 62 to which a plurality of wafer mounting heads 29a-d are coupled. Thus, a wafer W may be loaded onto the load cup 40 and loaded or mounted therefrom to the first wafer mounting head 29a while wafer mounting heads 29b-d press wafers against the polishing pads 17a-17c of the various polishing stations 52₁-52₃.

In operation, a first wafer W₁ is loaded (e.g., via a wafer handler that is not shown) onto load cup 60 and mounted therefrom to first wafer mounting head 29a. Rotatable cross bar 62 is indexed carrying the first wafer W₁ to the first polishing station 52₁ where wafer W₁ is to be polished, while a second wafer W₂ is loaded onto load cup 60 and mounted therefrom to the second wafer mounting head 29b. The rotatable cross bar 42 is indexed again; the wafer W₁ is polished by the second polishing station 52₂ (e.g., with a different polishing fluid than that used by the first polishing station 52₁); the second wafer W₂ is polished by the first polishing station 52 and a third wafer W₃ is loaded to the load cup 60 and mounted to the third wafer mounting head 29c.

Thereafter, rotatable cross bar 40 indexes and the first wafer W₁ is carried to polishing station 52₃. Meanwhile, the second wafer W₂ is polished by second polishing station 52₂; the third wafer W₃ is polished by first polishing station 52₁ and a fourth wafer W₄ is loaded onto load cup 60 and mounted to a fourth wafer mounting head 29d.

The rotatable cross bar 42 then indexes carrying the first wafer W₁ to load cup 60 where the first wafer mounting head 29a places the first wafer W₁ on the load cup 60 and a wafer handler (not shown) extracts the first wafer W₁ from the system 38.

In a typical inline process, once a wafer is transferred to a particular polishing station 52₁ to 52₃, the wafer is continuously polished at the particular station and then transferred to the next station. For example, if material of a thickness X is desired to be removed from wafer W at a station 52₁, wafer W is polished at station 52₁ in a continuous process until X material is removed. Then, wafer W is transferred to the next station for further polishing. During the wafer transfer process, the polishing pads 17a-17d may be conditioned and/or rinsed.

In contrast, inline polishing processes according to embodiments of the present invention polish wafers at one or more of the stations 52₁ to 52₃ using a process similar to that described with respect to FIG. 2. That is, after a wafer W is transferred to, for example, a head 29 at station 52₁, the wafer is partially polished by supplying a polishing fluid to pad 17₁ and holding the wafer down against the pad with an appropriate polishing force. Prior to completing polishing at station 52₁, the polishing force is removed (set to 0 psi), the supply of polishing fluid is stopped and pad 17₁ is rinsed to remove used polishing fluid. Thereafter, polishing resumes at station 52₁ by reinitiating the flow of polishing fluid to the pad and applying an appropriate polishing force. In this manner if X material is to be removed at station 52₁, a first portion of X is removed prior to the rinse step and the remaining portion of X is removed after the rinse step. The entire thickness of X is, however, removed at station 52₁.

IV. Comparative Examples

In order to test the effectiveness of the present invention, the inventors conducted multiple tests in which batch and inline polishing processes according to the present invention were compared to polishing processes without the benefit of the invention. The polishing tests were performed with the Hitachi Chemical slurry which is selective to nitride (it removes nitride at a much slower rate than oxide). The tests were performed on wafers having shallow trench isolation (STI) structures formed thereon. FIG. 4, which is not drawn to scale, shows an example of a substrate 200 in which STI features are formed. As shown in FIG. 4, substrate 200 includes active areas 205 and trenches 210. Trenches 210 are the isolation areas of the STI structure while active devices, e.g., transistors, are subsequently formed in each of active areas 205. Active areas 205 include a nitride etch stop layer 215 deposited over a thin pad oxide layer 220. The STI oxide 225 is deposited above active areas 205 and within trenches 210.

For each of the tests, measurements of the oxide thickness in the trench and nitride thickness above the active areas were taken to compare the planarity and uniformity of the process. Planarity was measured across the wafer and is discussed below as average WID (within die) range data representing the variation (in A) of the measurements. The lower the average WID range number, the better the performance. Uniformity was measured across the entire wafer and is discussed below as WIW (within wafer) data representing variations (in Å) of the measurements. Again, the lower the number, the better the performance. For the WID range measurements listed below, thickness measurements were taken at 10 different cites within a die on the wafer and the range between the thickest and thinnest measurements was calculated. Similar ranges were calculated for 10 different die across the wafer and then averaged. For the WIW measurements listed below, thickness measurements were taken from 10 different cites within a die and averaged. Similar averages were calculated for multiple die across the wafer and then the range in those averages was determined.

Listed below in Table 1 are test results for STI wafers polished in a batch process with and without the benefits of the present invention. For the data the STI structures on wafers 1 and 2 were substantially similar with each having oxide valleys approximately 4400 Å deep above the trench areas (measurement X in FIG. 4) and having approximately 3100 Å of oxide between the base of the valleys and top of the nitride layer (measurement Y in FIG. 4). Similarly, the STI structures on wafers 3 and 4 were substantially similar to each other and included 5,000 Å valleys and approximately 2,000 Å of oxide between the valleys and nitride layers.

Under the “process” column in Table 1 the #, #, # entries give times for the process where the first # is the initial polish time (e.g., step 110) the second # is the rinse time (e.g., step 120) and the third # is the second step polish time (e.g., step 130). After polishing, trench thickness for wafers 1 and 2 was approximately 4400 Å, while trench thickness for wafers 3 and 4 was approximately 5000 Å and nitride thickness for wafers 3 and 4 was approximately 1400 Å. “N/M” in the chart represents data values that were not measured.

TABLE 1
BATCH PROCESS TEST RESULTS

| Wafer | | Polish | Total | Avg. WID | Avg. WID | WIW | WIW |
|---|---|---|---|---|---|---|---|
| No. | Process | Time | Time | Trench | Nitride | Trench | Nitride |
| 1 | Batch, | 219 | 219 | 197 | n/m | 691 | n/m |
| | no rinse | | | | | | |
| 2 | Batch, | 102 | 122 | 126 | n/m | 335 | n/m |
| | 60, 20, 42 | | | | | | |
| 3 | Batch, | 236 | 236 | 411 | 66 | 465 | 111 |
| | no rinse | | | | | | |
| 4 | Batch, | 161 | 171 | 351 | 47 | 261 | 74 |
| | 90, 10, 71 | | | | | | |

As evident from Table 1, polishing results for wafer 2, which was polished in accordance with the present invention, were significantly improved compared to results for wafer 1 which was polished without the benefit of the present invention. Total process time for wafer 2 was 44.3% less than that for wafer 1, while WID trench measurements showed a 36.0% improvement and WIW trench measurements showed a 51.5% improvement. Similarly, polishing results for wafer 4, which was polished in accordance with the present invention, were significantly improved compared to results for wafer 3 which was polished without the benefit of the present invention. Total process time for wafer 4 was 27.5% less than that for wafer 3, while WID trench measurements showed a 14.6% improvement and WIW trench measurements showed a 43.9% improvement.

Listed below in Table 2 are test results comparing STI wafers polished in an inline process with and without the benefit of the present invention. Wafers 5-7 were polished on a first platen for the time indicated in the “process” column of Table 2 and then transferred to a second platen to complete polishing. The time the wafer is polished on the second column is the total polishing time minus the time listed in the process column. The second platen was rinsed with deionized water while the wafer was transferred from platen 1 to platen 2. Thus, wafers 1-3 were polished using a standard, previously known inline polishing procedure.

In contrast, wafer 4 was polished using the method of the present invention. As indicated in the “process” column, wafer 8 was polished on platen 1 for 60 seconds, platen 1 was rinsed for 10 seconds and then wafer 8 was further polished on platen 1 for an additional 60 seconds. Next, wafer 8 was transferred to platen 2 where it was polished for 60 additional seconds, platen 2 was rinsed for 10 seconds, then polishing was completed on platen 2 for 28 additional seconds.

The valleys for wafers 5-8 (measurement X) were approximately 5,000 Å, while the oxide thickness between the valleys and nitride layers (measurement Y) was approximately 10,000 Å.

TABLE 2
INLINE PROCESS TEST RESULTS

| Wafer | | Polish | Total | Avg. WID | Avg. WID | WIW | WIW |
|---|---|---|---|---|---|---|---|
| No. | Process | Time | Time | Trench | Nitride | Trench | Nitride |
| 5 | Inline (90) | 305 | 305 | 359 | 141 | 466 | 141 |
| 6 | Inline (90) | 278 | 278 | 576 | 88 | 586 | 146 |
| 7 | Inline | 379 | 379 | 367 | 78 | 491 | 179 |
| | 152 | | | | | | |
| 8 | 60, 10, 60 | 208 | 228 | 261 | 72 | 392 | 134 |
| | P1 to P2 | | | | | | |
| | 60, 10, 28 | | | | | | |

As evident from Table 2, the polishing results for wafer 8, which was polished in accordance with the present invention, are better in every respect over the results for each of wafers 5-7, which were polished without the benefit of the invention.

Having fully described several embodiments of the present invention, other equivalent or alternative methods of practicing the present invention will be apparent to those skilled in the art. For example, while the invention is described with reference to a horizontally-oriented rotational polishing device, the invention may be employed with any polishing device including vertically-oriented polishers and/or polishers which employ translating polishing pads or conveyor-type polishing bands. The invention may be employed with any type of polishing pad, hard polishing pads (e.g., cast polyurethane) soft, porous polishing pads (e.g., PVA or soft polyurethane) either of which may or may not have grooves formed or scribed therein. The grooves may form any pattern including an x-y grid. Accordingly, while the present invention has been disclosed in connection with the embodiments described above, it should be understood that other embodiments may fall within the spirit and scope of the invention, as defined by the following claims.

What is claimed is:

1. A multistep method of polishing a semiconductor substrate with a polishing fluid to remove a selected amount of material from said substrate, said method comprising:
polishing said substrate to remove a first portion of said selected amount of material by holding said substrate against a polishing pad with a polishing force while applying a polishing solution to said polishing pad;
rinsing said polishing pad with a rinsing fluid; and
polishing said substrate to remove a second portion of said selected amount of material by holding said substrate against said polishing pad with a polishing force while applying said polishing fluid to said polishing pad.

2. The method of claim 1 wherein said polishing fluid is an unstable polishing fluid.

3. The method of claim 1 wherein said first portion and said second portion equal said selected amount.

4. The method of claim 2 wherein said unstable polishing fluid is mixed in a point of use mixing system prior to applying said polishing solution to said polishing pad.

5. The method of claim 1 wherein said rinsing fluid comprises deionized water.

6. The method of claim 1 wherein said rinsing is done while said substrate is held against said polishing pad with a 0 psi force.

7. A multistep method of polishing a semiconductor substrate in an inline polishing that includes at least first and second polishing stations, wherein said first polishing station includes a first polishing pad and said second polishing station includes a second polishing pad, said method comprising:
transferring said substrate to said first polishing;
polishing said substrate to remove a first portion of material by holding said substrate against said first polishing pad with a polishing force while applying a first polishing solution to said first polishing pad;
rinsing said first polishing pad with a rinsing fluid;
polishing said substrate to remove a second portion of material by holding said substrate against said first polishing pad with a polishing force while applying said first polishing fluid to said first polishing pad;
transferring said substrate to said second polishing station; and
polishing said substrate to remove a third portion of material by holding said substrate against said second polishing pad with a polishing force while applying a second polishing solution to said second polishing pad.

8. The method of claim 7 wherein said polishing fluid is an unstable polishing fluid.

9. The method of claim 7 wherein said first portion and said second portion equal said selected amount.

10. The method of claim 8 wherein said unstable polishing fluid is mixed in a point of use mixing system prior to applying said polishing solution to said polishing pad.

11. The method of claim 7 wherein said rinsing fluid comprises deionized water.

12. The method of claim 7 wherein said rinsing is done while said substrate is held against said polishing pad with a 0 psi force.

13. The method of claim 7 wherein said substrate is transferred to and polished at said second polishing station before being transferred to and polished at said first polishing station.
